(19) United States
(12) Patent Application Publication
(10) Pub. No.: US 2005/0108588 A1
(43) Pub. Date: May 19, 2005

(54) System and method for starting up plural electronic devices in an orderly manner

(76) Inventor: Ming-Huan Yuan, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/838,964

(22) Filed: May 4, 2004

(30) Foreign Application Priority Data
Nov. 14, 2003 (TW) 92131965

(51) Int. Cl. G06F 1/32

(52) U.S. Cl. 713/330

(57) ABSTRACT

An exemplary system for starting up electronic devices in an orderly manner includes four power sources switches (118, 218, 318, 418) connected to a power source and respective hard drives (122, 222, 322, 422), and four controllers (112, 212, 312, 412) respectively connected to the power source switches. Each power source switch is for switching on and off an electronic connectivity between the power source and the corresponding hard drive. Each controller is configured for controlling switching on and off of a corresponding power source switch, and includes two input ends for defining a unique input of the controller, and an output end for transmitting an output of the controller to the corresponding power source switch. Outputs of the controllers for switching on the corresponding power source switches occur at different times after a common switching off time, the different times being determined by the unique inputs of the controllers.

### BACKGROUND OF THE INVENTION

1. Field of the Invention

The present invention relates to a system and method for starting up plural electronic devices in an orderly fashion, for example when plural hard drives on respective backboards need to be started up in an orderly manner.

2. Description of Related Art

Generally, a user of a computer system stores his/her data in a storage device of the system. When the data exceeds the capacity of the storage device, the user may connect plural storage devices in parallel in order to enlarge the total available capacity. The storage devices may be hard disk drives (“hard drives”), or other kinds of storage devices known in the art.

Each storage device has a driving current, for example, the driving current of a typical hard drive is 2 amperes. When a power source is turned on, current from the power source drives a motor of the hard drive so that the hard drive rotates and can operate. An initial instantaneous peak-value current of the hard drive is equivalent to the driving current of 2 amperes. Thereafter, a working current of the hard drive decreases to an average value of less than 2 amperes. If the user connects two hard drives in parallel, when the hard drives are driven by their respective motors simultaneously, the total instantaneous peak-value current of the hard drives is 4 amperes. When the user connects relatively few hard drives, the total instantaneous peak-value current can be easily supplied by the power source. However, if the user connects numerous hard drives, the total instantaneous peak-value current is correspondingly high. For example, eight hard drives require a total instantaneous peak-value current of 16 amperes. Commonly used power sources are not able to supply such a strong current. The user may therefore employ a special power source in order to solve this problem. However, the purchase and running costs of such power source are inevitably high.

Consequently, a system and method are needed for starting up plural devices in an orderly manner so as to decrease the instantaneous peak-value current required when the plural devices are started up.

### SUMMARY OF THE INVENTION

A first objective of the present invention is to provide a system for starting up plural devices in an orderly manner.

A second objective of the present invention is to provide a method for starting up plural devices in an orderly manner.

In order to fulfill the above-mentioned first objective, the present invention provides a system for starting up plural electronic devices in an orderly manner. In an exemplary embodiment of the invention, the electronic devices are hard drives. The system comprises a plurality of power source switches each of which is connected to a power source and a corresponding hard drive, and a plurality of controllers respectively connected to the power source switches. The power source switch is provided for switching an electronic connectivity between the power source and said corresponding hard drive on or off. Each of the controllers is configured for reading an input and providing a corresponding output to its corresponding power source switch for controlling switching on and off of the corresponding power source switch, and comprises two input ends that are preset to cooperatively provide a unique input to the controller, and an output end connecting to said corresponding power source switch for transmitting the output of the controller to the corresponding power source switch. The output of each controller is determined by the unique input thereof and a time delay that is preset.

In order to fulfill the above-mentioned second objective, the present invention provides a method for starting up plural electronic devices in an orderly manner. The method comprises the steps of: (i) presetting different unique inputs respectively for a plurality of controllers, each of the controllers being connected with one or more respective of the electronic devices by a respective power source switch; (ii) outputting by said controllers a default voltage level to the corresponding power source switches, for switching off corresponding electronic connectivities between a power source and the plural electronic devices; (iii) outputting a voltage level other than the default voltage level by a first one of the controllers to said respective power source switch when a first time delay after the outputting of the default voltage level by the first controller has elapsed, the first time delay being determined by the unique input of the first controller, for switching on the corresponding electronic connectivity between the power source and said one or more respective of the electronic devices; (iv) outputting a voltage level other than the default voltage level by a subsequent one of the controllers to said respective power source switch when a subsequent time delay after the outputting of the default voltage level by the subsequent controller has elapsed, the subsequent time delay being longer than the previous time delay, the subsequent time delay being determined by the unique input of the subsequent controller, for switching on the corresponding electronic connectivity between the power source and said one or more respective of the electronic devices; and (v) repeating the third of the above-described outputting steps if and as necessary for any further controller, respective power source switch and corresponding electronic connectivity between the power source and said one or more respective of the electronic devices.

Other objectives, advantages and novel features of the present invention will become more apparent from the following detailed description when taken in conjunction with the accompanying drawings, in which:

### BRIEF DESCRIPTION OF THE DRAWINGS

FIG. 1 is a schematic diagram of hardware infrastructure of an exemplary embodiment of the system according to the present invention, the hardware infrastructure comprising four controllers;

FIG. 2 is a diagram of input voltage levels and output voltage levels of the four controllers of FIG. 1, plotted in relation to lapse of time; and

FIG. 3 is a flow chart of an exemplary method for starting up plural devices in an orderly manner according to the present invention.

### DETAILED DESCRIPTION OF THE INVENTION

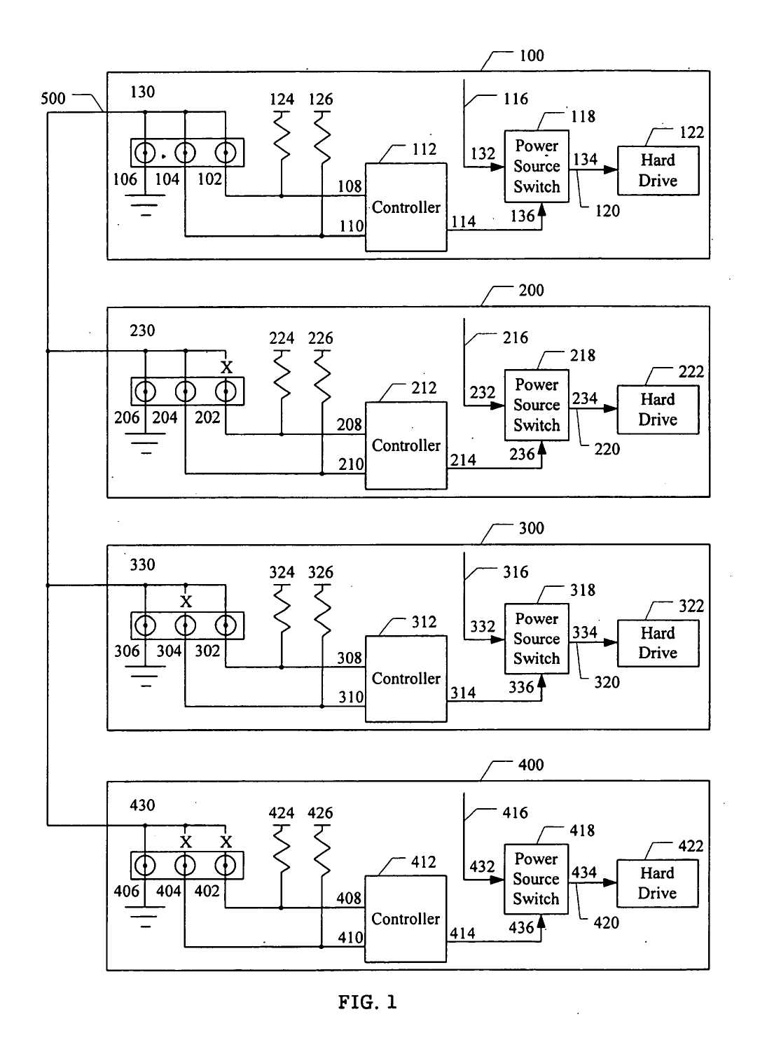

FIG. 1 is a schematic diagram of hardware infrastructure of a system for starting up plural electronic devices in an orderly manner according to the present invention. In the exemplary embodiment of the present invention described herein, four backboards are employed: a first backboard 100, a second backboard 200, a third backboard 300, and a fourth backboard 400. The backboards 100, 200, 300, and 400 are electronically connected together by a parallel line 500. The first backboard 100 comprises a controller 112, a power source switch 118, a hard drive 122, three interfaces 102, 104, and 106, two high voltage level nodes 124 and 126, and two cables 116 and 120. The controller 112 comprises two input ends 108 and 110, and an output end 114. Respective ends of the three interfaces 102, 104 and 106 are electronically connected to the parallel line 500 via a common connection node 130. An opposite end of the interface 106 is grounded. Respective opposite ends of the interfaces 102 and 104 are connected to the input ends 108 and 110 of the controller 112. In addition, the input ends 108 and 110 are respectively connected to the high voltage level nodes 124 and 126.

The power source switch 118 comprises an input end 132, an output end 134, and a control end 136. The input end 132 is connected to the cable 116, which in turn is connected with a power source (not shown). The output end 134 is connected to the hard drive 122 by the cable 120. The control end 136 is electronically connected to the output end 114 of the controller 112. Under control of the controller 112, the power source switch 118 switches an electronic connectivity between the power source and the hard drive 122 on and off. In the illustrated embodiment, when the controller 112 outputs a high voltage level, the power source switch 118 switches off the electronic connectivity. Conversely, when the controller 112 outputs a low voltage level, the power source switch 118 switches on the electronic connectivity. The voltage level output depends on inputs from the input ends 108 and 110. In an alternative embodiment, the controller 112 may be configured to output a low voltage level to switch off the electronic connectivity, and output a high voltage level to switch on the electronic connectivity.

In the illustrated embodiment, the second backboard 200, the third backboard 300 and the fourth backboard 400 have similar structures to that of the first backboard 100, as seen in FIG. 1. Like reference numerals correspond to like components. For the sake of brevity, the second, third and fourth backboards 200, 300, and 400 are not fully described in detail herein. The four backboards 100, 200, 300, and 400 are interconnected with each other through the parallel line 500 at connection nodes 130, 230, 330, and 430 thereof. Because the parallel line 500 is connected to the grounded interface 106, the parallel line 500 is always at a low voltage level. On the first backboard 100, because the interfaces 102 and 104 are connected to the parallel line 500, and are respectively electronically connected to the input ends 108 and 110, inputs from the input ends 108 and 110 are low voltage level inputs. In the illustrated embodiment, a low voltage level is represented by the number “0.” In contrast, a high voltage level is represented by the number “1.” Therefore, a total input to the controller 112 by way of the input ends 108 and 110 thereof is recorded as “00”

On the second backboard 200, an interface 202 that is electronically connected to an input end 208 of a controller 212 is shut off from the parallel line 500. In addition, the input end 208 is connected to a high voltage level node 224. Therefore, the input from the input end 208 is a high voltage level input. On the other hand, another input end 210 of the controller 212 which is connected to a high voltage level node 226 is grounded by way of an interface 204. Therefore the input from the input end 210 is a low voltage level input. Accordingly, a total input to the controller 212 by way of the input ends 208 and 210 thereof is recorded as “10.”

On the third backboard 300, an input end 308 of a controller 312 which connected to a high voltage level node 324 is grounded by way of an interface 302. Therefore, the input from the input end 308 is a low voltage level input. On the other hand, another interface 304 electronically connected to another input end 310 of the controller 312 is shut off from the parallel line 500. In addition, the input end 310 is connected to a high voltage level node 326. Therefore, the input from the input end 310 is a high voltage level input. Accordingly, a total input to the controller 312 by way of the input ends 308 and 310 thereof is recorded as “01.”

On the fourth backboard 400, two input ends 408 and 410 of a controller 412 are shut off from the parallel line 500, and are respectively connected to high voltage level nodes 424 and 426. Therefore, inputs from the input ends 408 and 410 to the controller 412 are high voltage level inputs, and a total input to the controller 412 is recorded as “11.”

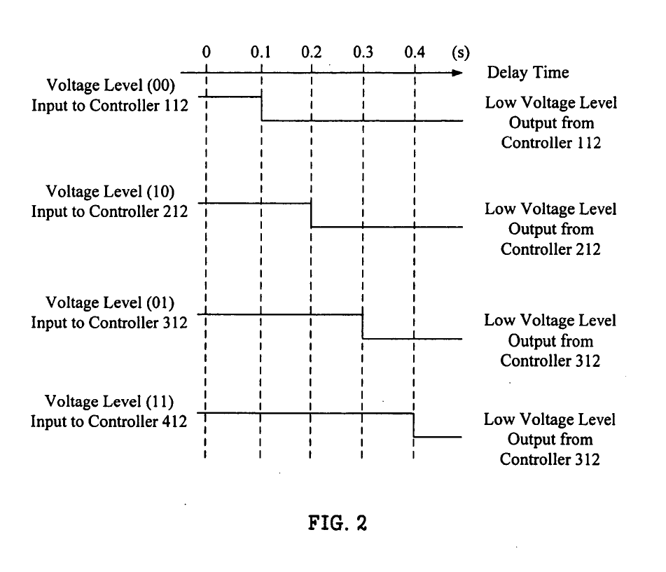

Based on their different total inputs, the controllers 112, 212, 312 and 412 are configured with different pre-determined time delays. Each time delay is a period of time between the moment when the respective controller 112, 212, 312, or 412 is powered on, and a moment when the respective controller 112, 212, 312, or 412 outputs a low voltage level from its respective output end 134, 234, 334, or 434. FIG. 2 illustrates the time delay of each controller 112, 212, 312, and 412 outputting a low voltage level after the controller 112, 212, 312, and 412 is powered on, on the assumption that the four controllers 112, 212, 312, and 412 simultaneously output respective high voltage levels immediately upon being powered on simultaneously at time “0.”

In the illustrated embodiment, the four controllers 112, 212, 312, and 412 are cooperatively configured so that: if the total input of the controller 112 is “00,” the controller 112 outputs a low voltage level after a first time delay such as 0.1 seconds; if the total input of the controller 212 is “10,” the controller 212 outputs a low voltage level after a second time delay such as 0.2 seconds; if the total input of the controller 312 is “01,” the controller 312 outputs a low voltage level after a third time delay such as 0.3seconds; and if the total input of the controller 412 is “11,” the controller 412 outputs a low voltage level after a fourth time delay such as 0.4 seconds. Each time delay is calculated from the moment when the respective controller 112, 212, 312, or 412 is powered on.

Under the above-described conditions, when the four controllers 112, 212, 312, and 412 are powered on simultaneously, they immediately output high voltage levels to corresponding power source switches 118, 218, 318, and 418. After the first time delay, the controller 112 outputs a low voltage level, and the power source switch 118 switches on the electronic connectivity between the power supply and the hard drive 122. After the second time delay, the controller 212 outputs a low voltage level, and a power source switch 218 switches on an electronic connectivity between the power supply and a hard drive 222. After the third time delay, the controller 312 outputs a low voltage level, and a power source switch 318 switches on an electronic connectivity between the power supply and a hard drive 322. After the fourth time delay, the controller 412 outputs a low voltage level, and a power source switch 418 switches on an electronic connectivity between the power supply and a hard drive 422. Thus, starting up of the hard drives 122, 222, 322, and 422 in an orderly manner is realized.

In the illustrated embodiment, the four backboards 100, 200, 300, and 400 are employed. In alternative embodiments, the number of backboards may be varied according to need. However many backboards are employed, a corresponding number of controllers is required. If the number of backboards is more than four, the number of input ends connected to each controller is more than two, in order to be able to provide the required number of different total inputs to the controllers. For example, when the number of the input ends of each of the controllers is three, there are eight different total inputs possible for the controllers. That is, the number of backboards may be between five and eight. In practice, it is believed that the maximum number of backboards employed is likely to be sixteen. Further, in an alternative embodiment, more than one hard drive may be provided on any backboard. For example, up to a few hard drives may be provided on any backboard. This is because when relatively few hard drives are connected to the power source simultaneously, the total instantaneous peak-value current can be readily supplied by the power source. Accordingly, if the number of backboards employed is sixteen, the total number of hard drives on the backboards may be more than sixteen.

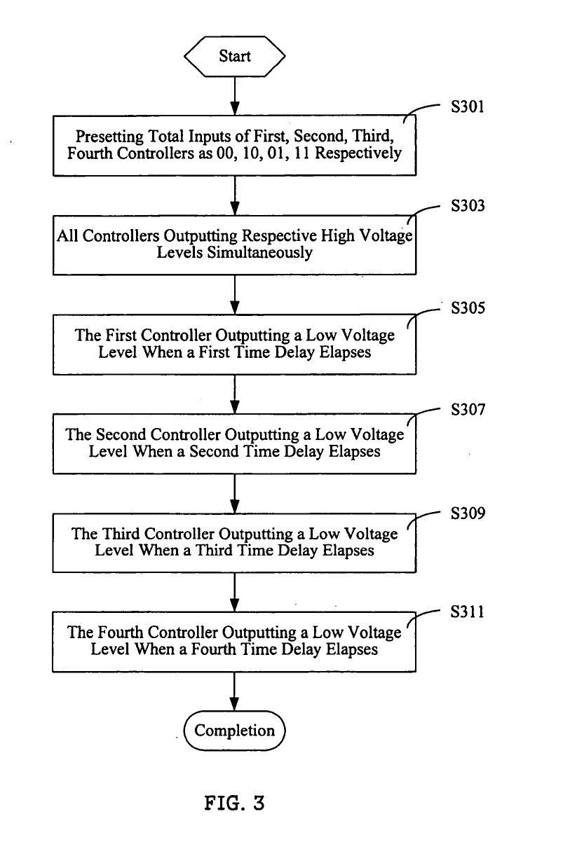

FIG. 3 is a flow chart of an exemplary method for starting up plural electronic devices in an orderly manner according to the present invention. At step S301, total inputs of the four controllers 112, 212, 312, and 412 are respectively preset as 00, 10, 01, and 11. Each “0” and “1” digit represents the low voltage level and the high voltage level respectively. When the above-described system of the present invention is powered on, at step S303, the four controllers 112, 212, 312, and 412 immediately output respective high voltage levels to the corresponding power source switches 118, 218, 318, and 418. The power source switches 118, 218, 318, and 418 switch off the respective electronic connectivities between the power source and the corresponding hard drives 122, 222, 322, and 422.

At the moment the predetermined first time delay (such as 0.1seconds) elapses, at step S305, the controller 112 with the total input of “00” outputs a low voltage level to the power source switch 118. The power source switch 118 switches on the electronic connectivity between the power source and the hard drive 122, which starts up the hard drive 122. At the moment the predetermined second time delay (such as 0.2 seconds) elapses, at step S307, the controller 212 with the total input of “10” outputs a low voltage level to the power source switch 218. The power source switch 218 switches on the electronic connectivity between the power source and the hard drive 222, which starts up the hard drive 222. At the moment the predetermined third time delay (such as 0.3 seconds) elapses, at step S309, the controller 312 with the total input of “01” outputs a low voltage level to the power source switch 318. The power source switch 318 switches on the electronic connectivity between the power source and the hard drive 322, which starts up the hard drive 322. At the moment the predetermined fourth time delay (such as 0.4 seconds) elapses, at step S311, the controller 412 with the total input of “11” outputs a low voltage level to the power source switch 418. The power source switch 418 switches on the electronic connectivity between the power source and the hard drive 422, which starts up the hard drive 422.

While a particular embodiment and particular method of the present invention have been described above, it should be understood that they have been presented by way of example only and not by way of limitation. Thus the breadth and scope of the present invention should not be limited by the above-described exemplary embodiment and method, but should be defined only in accordance with the following claims and their equivalents.

1. A system for starting up plural electronic devices in an orderly manner, the system comprising:
a plurality of power source switches each of which is connected to a power source and at least one of the electronic devices, for switching an electronic connectivity between the power source and the at least one electronic device on and off; and
a plurality of controllers respectively connecting to the power source switches, each of the controllers being configured for reading an input and providing a corresponding output to its corresponding power source switch to control switching on and off of the corresponding power source switch, each of the controllers comprising:
at least two input ends being preset to cooperatively provide a unique input to the controller; and
an output end connecting to the corresponding power source switch for transmitting the output of the controller to the corresponding power source switch.

2. The system as recited in claim 1, wherein the input ends of each of the controllers are respectively connected to a high voltage level source.

3. The system as recited in claim 2, wherein each of the input ends of each of the controllers is preset by being either grounded or not grounded.

4. The system as recited in claim 1, wherein the corresponding output of each of the controllers is a change in a voltage level output to the corresponding power source switch.

5. The system as recited in claim 4, wherein when each of the controllers is powered on, the controller outputs a default voltage level to its corresponding power source switch for switching off said electronic connectivity between the power source and the at least one electronic device.

6. The system as recited in claim 5, wherein the corresponding output of each of the controllers is a voltage level other than the default voltage level, and is output after a unique time delay has elapsed from outputting of the default voltage level, the unique time delay being determined by the unique input to the controller.

7. A method for starting up plural electronic devices in an orderly manner, the method comprising the steps of:
presetting different unique inputs respectively for a plurality of controllers, each of the controllers being connected with one or more respective of the electronic devices by a respective power source switch;
outputting by said controllers of a default voltage level to the respective power source switches, for switching off corresponding electronic connectivities between a power source and the electronic devices;
outputting a voltage level other than the default voltage level by a first one of the controllers to said respective power source switch when a first time delay after the outputting of the default voltage level by the first controller has elapsed, the first time delay being determined by the unique input of the first controller, for switching on the corresponding electronic connectivity between the power source and said one or more respective of the electronic devices;
outputting a voltage level other than the default voltage level by a subsequent one of the controllers to said respective power source switch when a subsequent time delay after the outputting of the default voltage level by the subsequent controller has elapsed, the subsequent time delay being longer than the previous time delay, the subsequent time delay being determined by the unique input of the subsequent controller, for switching on the corresponding electronic connectivity between the power source and said one or more respective of the electronic devices; and
repeating the third of the above-described outputting steps if and as necessary for any further controller, respective power source switch and corresponding electronic connectivity between the power source and said one or more respective of the electronic devices.

8. The method as recited in claim 7, wherein the step of presetting different unique inputs respectively for the controllers comprises the step of presetting each of two or more input ends of each of the controllers as being either grounded or not grounded.

9. The method as recited in claim 7, wherein each of said controllers is connected to two high voltage level nodes via two input ends thereof, and further connected to two interfaces under a condition that another interface and said two interfaces define respective ends commoned with a same line.

10. A system for starting up plural electronic devices in an orderly manner, the system comprising:
a plurality of power source switches each of which is connected to a power source and at least one respective of the electronic devices, each of the power source switches being for switching on and off an electronic connectivity between the power source and the at least one respective of electronic devices, whereby when the electronic connectivity is switched on, the at least one respective of the electronic devices is started up; and
a plurality of controllers connecting to respective power source switches, for providing respective outputs to the respective power source switches in order to control switching on and off of the respective power source switches, each of the controllers comprising: at least two input ends for defining a unique input of the controller; and an output end connecting to the respective power source switch for transmitting the output of the controller to the respective power source switch;
wherein when powered on, each of the controllers outputs a default voltage level to switch off the respective power source switch, and when a unique time delay has elapsed from the moment of powering on of the controller, the controller outputs a voltage level other than the default voltage level to switch on the respective power source switch, the unique time delay being determined by the unique input of the controller;
a plurality of high voltage level nodes respectively connecting to the input ends of the controllers;
a plurality of interfaces, first ends of the interfaces respectively connecting to the input ends of the controllers; and
a plurality of connection nodes connecting to second ends of the interfaces, the connection nodes being electronically connected with each other and commonly grounded;
wherein one or more of the interfaces shuts off a connectivity between the first and second ends thereof, for providing a unique total input to the input ends of each of the controllers.
